(19) United States
(12) Patent Application Publication
(10) Pub. No.: US 2020/0144874 A1
(43) Pub. Date: May 7, 2020

(54) ELECTRIC MACHINE WITH INTERFERENCE FIT HOUSING

(71) Applicant: Ford Global Technologies, LLC, Dearborn, MI (US)

(72) Inventors: Chun Tang, Canton, MI (US); Joel Hetrick, Ann Arbor, MI (US); Shailesh Shrikant Kozarekar, Novi, MI (US)

(21) Appl. No.: 16/179,127

(22) Filed: Nov. 2, 2018

(51) Int. Cl. H02K 1/16; H02K 1/18

(52) U.S. Cl. CPC H02K 1/16; H02K 1/185

(57) ABSTRACT

An electric machine includes a stator core having integrally formed resilient features circumferentially arranged around an outer diameter of the core and a cylindrical housing receiving the core with the resilient features disposed against an inner diameter of the housing. The outer diameter is larger than the inner diameter to form an interference fit between the core and housing, and the resilient features are configured to radially displace responsive to the inner diameter shrinking.

### TECHNICAL FIELD

This disclosure relates to electric machines, and more specifically to electric machines that include an interference fit between the housing and the stator core.

### BACKGROUND

Vehicles such as battery-electric vehicles and hybrid-electric vehicles contain a traction-battery assembly to act as an energy source for the vehicle. The traction battery may include components and systems to assist in managing vehicle performance and operations. The traction battery may also include high-voltage components, and an air or liquid thermal-management system to control the temperature of the battery. The traction battery is electrically connected to an electric machine that provides torque to driven wheels. Electric machines typically include a stator and a rotor that cooperate to convert electrical energy into mechanical motion or vice versa.

### SUMMARY

According to one embodiment, an electric machine includes a stator core having integrally formed resilient features circumferentially arranged around an outer diameter of the core and a cylindrical housing receiving the core with the resilient features disposed against an inner diameter of the housing. The outer diameter is larger than the inner diameter to form an interference fit between the core and the housing, and the resilient features are configured to radially displace responsive to the inner diameter shrinking.

According to another embodiment, an electric machine includes a stator core having integrally formed resilient features circumferentially arranged around an outer diameter of the core. A cylindrical housing of the electric machines receives the core therein with the resilient features disposed against an inner diameter of the housing. The outer diameter is larger than the inner diameter to form an interference fit between the core and housing, and the resilient features are configured to radially displace responsive to the inner diameter shrinking.

According to yet another embodiment, an electric machine includes a stator core having an outer surface defining axially extending channels that are circumferential spaced around the core to form ridges between the recesses. The core further defines axially extending apertures located in an outer portion of the core and radially aligned with the ridges such that the channels and apertures cooperate to define flex bridges each composed of one of the ridges and a pair of arms. The flex bridges are radially deflectable into the apertures. A cylindrical housing receives the core such that the ridges form an interference fit with the core.

### BRIEF DESCRIPTION OF THE DRAWINGS

FIG. 1 is a schematic diagram of an electric machine.

FIG. 2 is a perspective view of a stator of the electric machine.

FIG. 3 is a cross-sectional view of a housing that is interference fit to a stator core having flex bridges.

FIG. 4 is a magnified view of the stator core of FIG. 3 at area 4.

FIG. 5 is cross-sectional view of a housing that is interference fit to a stator core having deformable projections according to one embodiment.

FIG. 6 is cross-sectional view of a housing that is interference fit to a stator core having deformable projections according to another embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

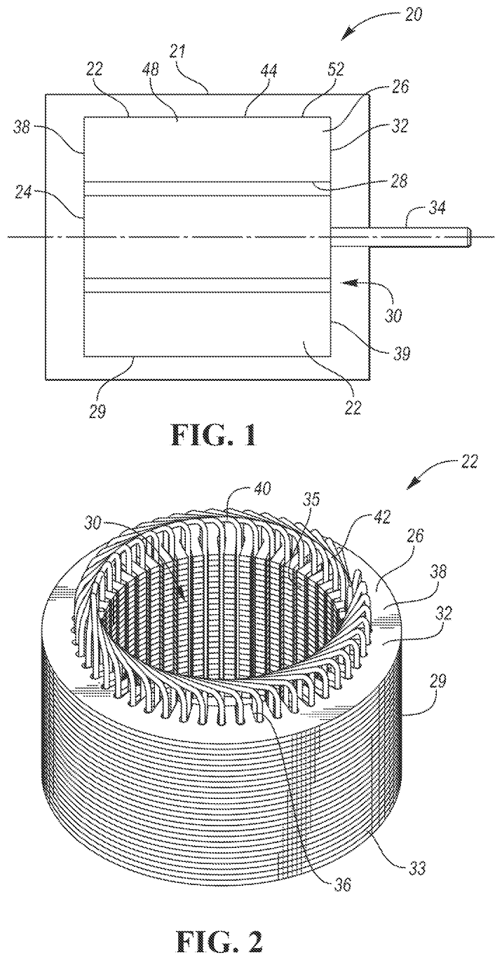

Referring to FIG. 1, an electric machine 20 may be used in a vehicle such as a fully electric vehicle or a hybrid-electric vehicle. The electric machine 20 may be referred to as an electric motor, a traction motor, a generator, or the like. The electric machine 20 may be a permanent magnet machine, an induction machine, or the like. In the illustrated embodiment, the electric machine 20 is a three-phase alternating current (AC) machine. The electric machine 20 is capable of acting as both a motor to propel the vehicle and as a generator such as during regenerative braking.

The electric machine 20 may be powered by a traction battery of the vehicle. The traction battery may provide a high-voltage direct current (DC) output from one or more battery-cell arrays, sometimes referred to as battery-cell stacks, within the traction battery. The battery-cell arrays may include one or more battery cells that convert stored chemical energy to electrical energy. The cells may include a housing, a positive electrode (cathode), and a negative electrode (anode). An electrolyte allows ions to move between the anode and cathode during discharge, and then return during recharge. Terminals allow current to flow out of the cells for use by the vehicle.

The traction battery may be electrically connected to one or more power electronics modules. The power electronics modules may be electrically connected to the electric machines 20 and may provide the ability to bi-directionally transfer electrical energy between the traction battery and the electric machine 20. For example, a typical traction battery may provide a DC voltage while the electric machine 20 may require a three-phase (AC) voltage. The power electronics module may include an inverter that converts the DC voltage to a three-phase AC voltage as required by the electric machine 20. In a regenerative mode, the power electronics module may convert the three-phase AC voltage from the electric machine 20 acting as a generator to the DC voltage required by the traction battery. While the electric machine 20 is described as a traction motor for a vehicle, this disclosure is not limited to any particular application. The electric machine 20, for example, may also be used in industrial equipment, electrical generation, and the like.

Referring to FIGS. 1 and 2, the electric machine 20 includes a housing 21 that encloses the stator 22 and the rotor 24. The stator 22 is fixed to the housing 21 and includes a cylindrical core 26 having an inner surface 28 that defines a hole 30 and an outer surface 29. The core 32 may be formed from a plurality of stacked laminations 33. The rotor 24 is supported for rotation within the hole 30. The rotor 24 may include windings or permanent magnets that interact with windings of the stator 22 to generate rotation of the rotor 24 when the electric machine 20 is energized. The rotor 24 may be supported on a driveshaft 34 that extends through the housing 21. The driveshaft 34 may be configured to couple with a drivetrain of the vehicle or other load.

The core 32 defines a plurality of teeth 35 extending radially inward. Adjacent teeth 35 cooperate to define slots 36 circumferentially arranged around the core 32. The slots 36 may be equally spaced around the circumference and extend axially from a first end 38 of the core 32 to a second end 39. A plurality of coil windings 40 are wrapped around the stator core 32 and are disposed within the slots 36. Portions of the wires generally extend in an axial direction through the slots 36. At the stator core ends 38, 39, the windings bend to extend circumferentially around the top or bottom of the stator core 32 forming the end windings 42.

The housing 21 may be secured to the stator core 32 by an interference fit (also known as a press fit). The interference fit may be supplemented by fasteners or other joining means. An interference fit can be formed by inserting an inner component into an outer component having an inner diameter that is smaller than an outer diameter of the inner component. The tightness of an interference fit is based on the amount of interference (size difference between the inner and outer diameters). The electric machine 20 may include an interference fit between an inner surface 44 of the housing 21 and the outer surface 29 of the core. Interference fitting the housing 21 directly onto the core 26, however, is problematic when the housing and the core are formed of different materials that have different coefficients of thermal expansion (CTE).

The stator core 26 is typically formed from steel whereas the housing 21 is typically formed of a lighter weight material such as aluminum. The CTE of aluminum is roughly double that of steel. This CTE difference causes the amount of interference between the steel core and the aluminum housing to change based on temperature. At high temperatures, the amount of interference is reduced due to the expansion of the housing relative to the core, and, at low temperatures, the amount of interference is increased due to the contraction of the aluminum housing relative the steel core.

Testing and simulation by Applicant has determined that a loss of interference can occur at the upper operating temperature range of a traction motor leading to the release of the stator core from the housing, and excessive interference can occur at the lower operating temperature range of the traction motor leading to stator or housing damage. For example, the aluminum housing may crack due to excessive interference at lower temperatures.

This disclosure proposes to form resilient features on the stator core to increase system compliance so that proper interference is maintained at the upper operating range of temperatures and so that damage is avoided at the lower operating range of temperatures. The resilient features are located near the outer surface 29 of the stator core 26 and make the outer portion of the stator core compressible relative to the remainder of the stator core. This allows for a tighter interference fit, i.e., more interference between stator and housing, at room temperature so that sufficient interference remains in the upper operating range of temperatures while being compressible to prevent damage at the lower operating range of temperatures.

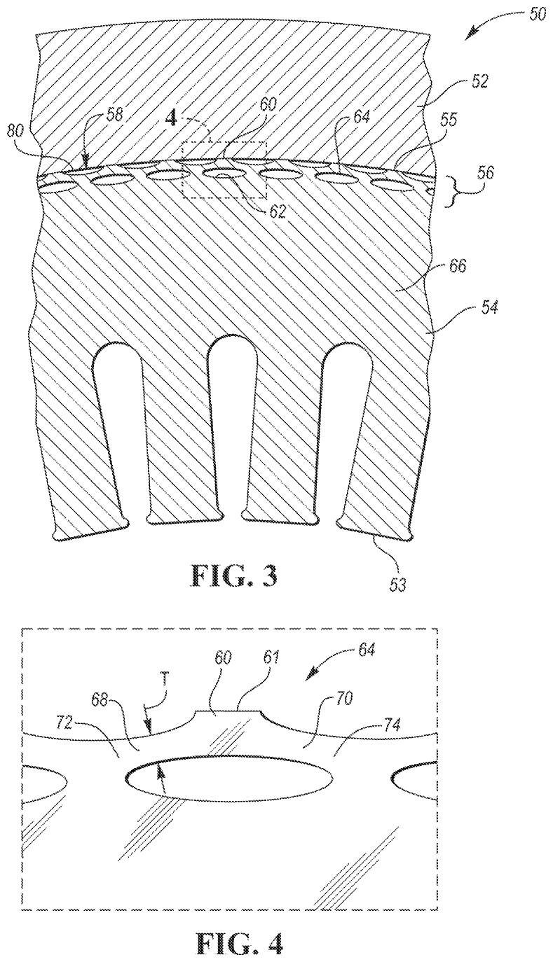

Referring to FIG. 3, an electric machine 50 includes a housing 52 that is interference fit to a stator core 54. The housing 52 may be made of aluminum and the stator core 54 may be made of steel laminations. The outer portion 56 of the core 54 is more compressible to facilitate the feasibility of press fitting the housing 52 to the stator core 54. The stator core 54 has an outer surface 55 defining channels 58 that are circumferentially arranged around the circumference of the core 54. The channels 58 may be equally. The channels 58 extend axially along the length of the core 54. The channels 58 may or may not extend the complete length of the stator core 54. The channels 58 may have a generally arcuate cross-section such as elliptical (as shown) or circular. In the illustrated embodiment, the elliptical channels 58 are have the major axis tangential to the circumferential direction of the stator core 54 and the minor axis radial to the stator core 54.

The channels 58 are spaced apart so that a plurality of ridges 60 are defined between the channels 58. The ridges 60 are the outer-most portions of the stator core 54, and the outer diameter of the stator core is measured between diametrically opposite ridges. Each of the ridges 60 includes a outer face 61 that is arcuate in the circumferential direction of the stator core 54. The outer faces 61 are the portion of the stator core 54 that press fit to the housing 52.

A plurality of apertures 62, such as elliptical holes, are defined in the outer portion 56 of the core 54. The outer portion 56 includes the outer 80 percent of the stator core measured radially. For example, if the stator core had a radial thickness of 100, (e.g., measured radially from the inner surface 53 to the outer surface 55, the outer portion 56 is located between 80 and 100. Depending upon the design, the apertures 62 may be located anywhere within the outer portion 56; however, it may be advantageous to have the apertures 62 as near to the outer surface 55 as possible. For example, the apertures 62 may be fully contained within the outer 90 percent or the outer 95 percent depending the particular design of the electric machine.

The elliptical holes 62 may be oriented with the major axes generally extending in the circumferential direction of the stator core 54, i.e., the major axes may be tangential to a common circle on which the centers of the ellipses lie. The apertures 62 are circumferentially arranged around the stator core 54 under the outer surface 55. The apertures 62 may be radially aligned with the ridges 60, i.e., centers of the apertures 62 are radially aligned with midpoints of the ridges 60.

The apertures 62 and the channels 58 remove material from the stator core 54 creating flex bridges 64. The flex bridges 64 encircle the stator core 54. The flex bridges 64 act as integrally formed resilient members of the stator core 54 and cause the outer surface 55 to be compressible relative to the main portion 66 of the stator core. The flex bridges 64 may extend axially along the length of the stator core 54.

Referring to FIG. 4, each of the flex bridges 64 includes a first arm 68 and a second arm 70 that are joined at the ridges 60. The first arm 68 extends from a first end 72 of the flex bridge 64 to the ridge 60, and the second arm 70 extends from the ridge 60 to the second end 74 of the flex bridge 64. The arms 68 and 70 are slender and deflectable providing the flex bridges 64 with radial resiliency. For example, the minimum radial thickness (T) of the arms 68, 70 may be between 0.5 to 3 millimeters (mm). The aperture 62 provides a void space for the flex bridge 64 to deflect radially inward. The flex bridges 64 deflect radially inward into the apertures 62 responsive to compressive force on the stator core 54 exceeding a threshold. This reduces the change in clamping pressure over large temperature ranges and thus prevents damage to the housing and stator core. For example, the flex bridges 64 deflect radially inward when the housing 52 contracts onto the core 54 at lower temperatures to prevent damage to the housing 52 and/or the stator core 54.

Referring back to FIG. 3, the housing 52 includes an inner surface 80 defining an inner diameter of the housing. The housing 52 is has a tubular cross-section and receives the stator core 54 therein. The outer diameter of the stator core 54 is larger than the inner diameter of the housing 52 so that an interference fit is formed between the ridges 60 and the inner surface 80. The flex bridges 64 are designed to flex radially inward while also providing sufficient stiffness to create a satisfactory interference fit with the housing 52 over a range of temperatures. The flex bridges 64 move radially inward and outward according to the temperature of the electric machine 50. This maintains a suitable interference between the housing 52 and the stator core 54 over the operating range of temperatures while also preventing damage to the electric machine 50.

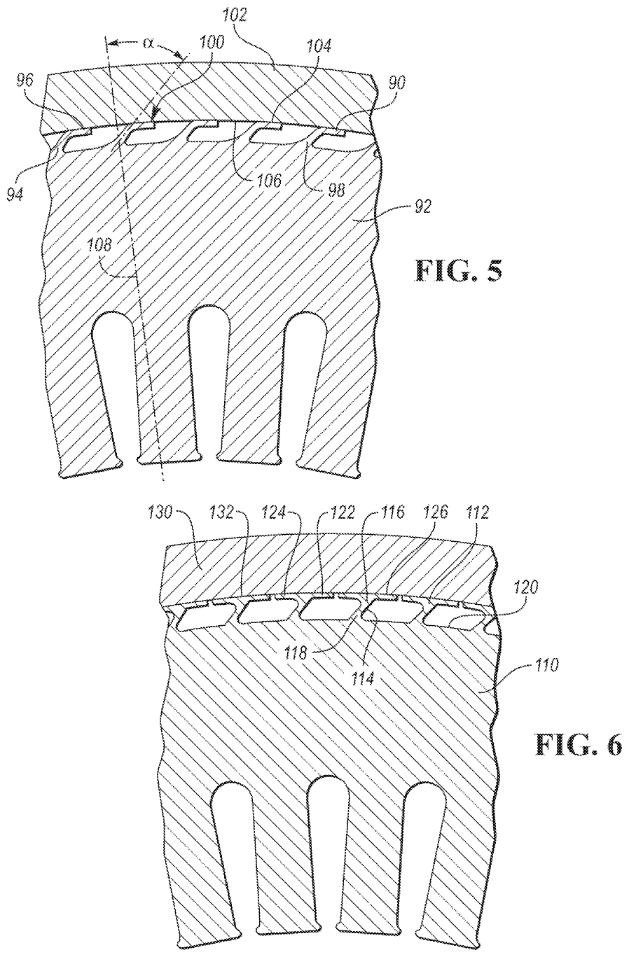

Referring to FIG. 5, the flex bridges are but one example of integrally formed resilient members of a stator core. Another example are deformable projections 90. The deformable projections 90 are circumferentially arranged around a perimeter of the stator core 92. The deformable projections 90 may be equally spaced. The projections may be spaced at many different intervals depending upon the embodiment. For example, the projections may be spaced at 5 degrees, 10 degrees, 15 degrees, 20 degrees, 30 degrees, 40 degrees and any value in between. The projections increase in size as the spacing increases. Therefore, it may be preferable to space the projections between the 5 to 15 degrees range to reduce the size of the projections. Also, increasing the number of projections by using smaller, more tightly spaced projections provides a more uniform interference fit.

The deformable projections 90 may be formed by stamping individual circular laminations to have a plurality of fingers. The laminations are then stacked with the fingers aligned to form the projections 90 that extend axially along the stator core 92.

Each projection 90 may having a neck 94 and a head 96. The neck 94 has a base 98 that is attached to circumferential surface 100. The neck 94 extends radially outward from the base 98. The neck 94 may be obliquely angled relative to a radial line 108 that extends to the base 98. The head 96 is attached to the neck 94 and extends circumferentially therefrom. The head 96 acts much like a cantilever beam and is deflectable. The head 96 includes an outer surface 104 configured to frictionally engage with the housing 102 of the electric machine. The projections 90 may all face in the same direction (clockwise as shown) or may face in both directions, i.e., a first set of projections faces clockwise, and a second set of projections face counterclockwise.

The projections 90 are radially deflectable so that the outer diameter of the stator core 92 can expand and contract as needed to maintain a proper interference fit while also preventing damage to the housing and/or the stator core. The outer diameter of the stator core 92 is measured between diametrically opposing outer surfaces 104. The heads 96 cooperate to define a discontinuous outer diameter of the stator core 92. The stator core 92 is received within the housing 102, which has an inner diameter that is smaller than the discontinuous outer diameter of the stator core 92 to form an interference fit. The heads 96 frictionally engage with the inner surface 106 to retain the housing onto the stator core 92. Typical housings are formed of a material, e.g. aluminum, having a larger CTE than the steel laminations of the stator core and thus the housing expands and contracts relative to the stator core due to temperature variance. The projections 90 are deflectable relative to the main portion of the stator core 92 to accommodate the expanding and contracting housing as discussed in more detail above. The necks 94 may be angled relative to radial line 108 at an oblique angle (a) to facilitate delectability of the projections 90.

FIG. 6 illustrates another type of integrally formed resilient member. A stator core 110 includes a plurality of deformable projections 112 that are circumferentially arranged around a perimeter of the stator core 110. The deformable projections 112 may be equally spaced. The projections 112 may be spaced at many different intervals depending upon the embodiment. For example, the projections may be spaced at 5 degrees, 10 degrees, 15 degrees, 20 degrees, 30 degrees, 40 degrees and any value in between. The projections increase in size as the spacing is increased. Therefore, it may be preferable to space the projections between the 5 to 15 degrees range to reduce the size of the projections. Also, increasing the number of projections by using smaller, more tightly spaced projections provides a more uniform interference fit.

The deformable projections 112 may be formed by stamping individual circular laminations to have a plurality of generally T-shaped features. The laminations are then stacked with the features aligned to form the projections 112 that extend axially along the stator core 110.

Each projection 112 may having a neck 114 and a head 116. The neck 114 has a base 118 that is attached to a circumferential surface 120. The neck 114 extends radially outward from the base 118 at an oblique angle relative to a radial line that extends through the base 118. The head 116 is attached to the neck 114 and extends circumferentially therefrom in both directions to form a first overhanging portion 122 and a second overhanging portion 124. The head 116 includes an outer surface 126 configured to frictionally engage with the housing 130 of the electric machine.

The projections 112 are radially deflectable so that the outer diameter of the stator core 110 can expand and contract as needed to maintain a proper interference fit while also preventing damage to the housing and/or the stator core. The outer diameter of the stator core 110 is measured between diametrically opposing outer surfaces 126. The heads 116 cooperate to define a discontinuous outer diameter of the stator core 110. The stator core 110 is received within the housing 130, which has an inner diameter 132 that is smaller than the discontinuous outer diameter of the stator core 110 to form an interference fit. The heads 116 frictionally engage with the inner surface 132 to retain the housing onto the stator core 92.

Typical housings are formed of a material, e.g., aluminum, having a larger CTE than the steel laminations of the stator core and thus the housing expands and contracts relative to the stator core due to temperature variance. The projections 112 are deflectable relative to the main portion of the stator core 110 to accommodate the expanding and contracting housing as discussed in more detail above. The projection 112 deflects, mainly, due to the angled neck 114 rotating about the base 118. The angle of the neck 114 is a tunable parameter that may be used to increase or decrease the stiffness of the projections 90. Generally, increasing the angle of the neck 114 reduces the stiffness of the projection 112 and vice versa.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An electric machine comprising:
a stator core having an outer surface defining axially extending channels that are circumferential spaced around the core to form ridges between the channels, the core further defining axially extending apertures located in an outer portion of the core and radially aligned with the ridges; and
a cylindrical housing receiving the core such that the ridges form an interference fit with the core.

2. The electric machine of claim 1, wherein centers of the apertures are radially aligned with centerlines of the ridges.

3. The electric machine of claim 1, wherein the apertures have elliptical cross-sections.

4. The electric machine of claim 3, wherein major axes of the elliptical cross-sections are tangential to a circumferential direction of the stator core.

5. The electric machine of claim 1, wherein the channels and the apertures cooperate to define flex bridges configured to radial deform into the apertures.

6. The electric machine of claim 5, wherein the ridges are located at midpoints of the flex bridges.

7. The electric machine of claim 1, wherein the channels are elliptical.

8. The electric machine of claim 1, wherein a diameter of the core between opposing ridges is larger than an inner diameter of the housing.

9. The electric machine of claim 1, wherein the housing and the stator core are formed of different materials.

10. The electric machine of claim 1, wherein the apertures are radially located in an outer 90 percent of the stator core.

11. The electric machine of claim 1 further comprising:
electric windings attached to the stator core; and
a rotor supported for rotation within the stator core.

12. An electric machine comprising:
a stator core having integrally formed resilient features circumferentially arranged around an outer diameter of the core; and
a cylindrical housing receiving the core with the resilient features disposed against an inner diameter of the housing, wherein the outer diameter is larger than the inner diameter to form an interference fit between the core and housing, and the resilient features are configured to radially displace responsive to the inner diameter shrinking.

13. The electric machine of claim 12, wherein the resilient features are deformable projections extending from the outer diameter of the core.

14. The electric machine of claim 13, wherein each of the projections includes a neck connected to the outer diameter and a head disposed on an end of the neck and being arranged to extend circumferentially to engage with the inner diameter of the housing, wherein the neck extends at an angle that is oblique relative to a radial direction of the core.

15. The electric machine of claim 12, wherein the resilient features are flex bridges.

16. The electric machine of claim 15, wherein the flex bridges are defined by channels extending into the outer diameter and apertures defined in the stator core.

17. An electric machine comprising:
a stator core having an outer surface defining axially extending channels that are circumferential spaced around the core to form ridges between the channels, the core further defining axially extending apertures located in an outer portion of the core and radially aligned with the ridges such that the channels and apertures cooperate to define flex bridges each composed of one of the ridges and a pair of arms, wherein the flex bridges are radially deflectable into the apertures; and
a cylindrical housing receiving the core such that the ridges form an interference fit with the core.

18. The electric machine of claim 17, wherein a diameter of the core between opposing ridges is larger than an inner diameter of the housing.

19. The electric machine of claim 17, wherein centers of the apertures are radially aligned with centerlines of the ridges.

20. The electric machine of claim 17, wherein the housing and the stator core are formed of different materials.
